(19) United States
(12) Patent Application Publication
(10) Pub. No.: US 2019/0310710 A1
(43) Pub. Date: Oct. 10, 2019

(54) Dynamic Haptic Feedback Systems

(71) Applicant: Ultrahaptics Limited, Bristol (GB)

(72) Inventors: Simon Deeley, Bristol (GB); Hamish Milne, Bristol (GB); Brygida Dzidek, Warsaw (PL)

(21) Appl. No.: 16/374,301

(22) Filed: Apr. 3, 2019

Related U.S. Application Data
(60) Provisional application No. 62/652,872, filed on Apr. 4, 2018.

(51) Int. Cl. G06F 3/01; G06F 3/041

(52) U.S. Cl. CPC G06F 3/016; G06F 3/041; G06F 3/017

(57) ABSTRACT

A system and method for the development, encapsulation, distribution and deployment of low-latency input-output processing algorithms to mediate human-computer interaction by generating haptic feedback influenced in real time by external stimuli. The invention provides the ability to design algorithms that scale or are otherwise automatically adjusted when deployed to computing environments with different capabilities. The invention also provides features to facilitate the design, sharing and modification of the algorithms, thereby reducing development time/cost.

### RELATED APPLICATION

This application claims the benefit of the following U.S. Provisional Patent Applications, which is incorporated by reference in its entirety:

1) Ser. No. 62/652,872, filed on Apr. 4, 2018.

### FIELD OF THE DISCLOSURE

The present disclosure relates generally to improved techniques for creating and monitoring dynamic haptic feedback systems.

### BACKGROUND

Mid-air haptics can be used to mediate human-computer interaction. During an interaction, haptic feedback can be used to convey many types of information to the user, for example:
the availability of interaction means such as buttons, switches, dials, menus, etc.
the current state of those interaction means, e.g. active/inactive, physical location, currently selected item, current setting, the attachment of a control to the user's hand, the rate of change of a setting etc.
the state of the computer itself
information about the environment in which the interaction is taking place
information about a virtual or remote environment
information about the success or failure of the user's attempts to issue commands
information about a change of state or other transient condition

Haptic feedback generation is often required to occur with low latency in response to the user's position, movements and gestures. To create the illusion of operating a control, such as twisting a dial or moving a slider, an input-processing method and haptic feedback generation method must be co-designed and deployed.

Generally, input processing and output generation are treated as separate concerns and dealt with in different parts of a system. Defining a haptic control comprising input-processing methods and output generation methods so that it can be easily designed in one environment and deployed to another where it reproduces the designed behavior is therefore a difficult problem.

Related art exists in graphics where it is common to define shaders, which are analogous to the method for generating haptic feedback, that produce image output by applying the method to run-time inputs.

Mid-air haptic mediated human-computer interaction (HCI) is a feedback loop comprising an output device (the array) generating output to be perceived by a user, user actions that are sensed by an input device (tracking device), and low-latency feedback to the output used to create the illusion of a physical interaction. There is an analogy with touch-screens and the corresponding user interface (UI) widgets that graphical user interface (GUI) programming libraries provide to take advantage of that particular device arrangement. Although it is possible to create and share extensions to GUI programming libraries, the incorporation of shared extensions normally requires substantial programming effort and build-time activities. The present invention affords the ability to define, encapsulate, share and deploy more easily than the existing methods.

### SUMMARY

Discussed herein is a system and method for the development, encapsulation, distribution and deployment of low-latency input-output processing algorithms to mediate human-computer interaction by generating haptic feedback influenced in real time by external stimuli. The invention provides the ability to design algorithms that scale or are otherwise automatically adjusted when deployed to computing environments with different capabilities. The invention also provides features to facilitate the design, sharing and modification of the algorithms, thereby reducing development time/cost.

Unlike graphics shaders, haptic blocks can generate outputs for connection to parts of the system other than the haptic emitter to indicate such conditions as a button being pressed or a notched dial being moved to the next notch. This is accomplished by scaling paths independently of brushes (by preserving data types/information in the block network rather than going directly to stream of focal point data).

### BRIEF DESCRIPTION OF THE FIGURES

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a schematic of an overall haptic system.

FIG. 2 shows a schematic of a block evaluator is provided that evaluates a network of blocks having inputs and outputs.

FIG. 3 shows a schematic of blocks that produces a haptic line that tracks the position and orientation of the palm of a hand.

FIG. 4 shows an arrangement of interconnected blocks that when evaluated detect a gesture.

FIG. 5 shows a schematic cylindrical zone that conceptually acts as a plunger.

FIG. 6 shows a schematic block network, for evaluation by a block evaluator, that implements the plunger behavior.

FIG. 7 shows a schematic of the effects of blocks or sub-networks each concerned with features at different scales.

FIG. 8 shows a schematic of an augmentation of the plunger arrangement of FIG. 6 with a sub-network.

FIG. 9 shows a schematic of an adapter block that converts a system data source interface for a gesture to an interface compatible with a sink block's input interface.

FIG. 10 shows a schematic of an evaluation of the “Result” channel of the comparator connection.

FIG. 11 shows a schematic of an application of channels showing how the scheme can be used to represent geometric paths.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. Defined Terms

The term ‘haptic point’ means a small region in space having perceptible physical properties that can be detected through the sense of touch alone and with the sensation being localized to a small region of skin such that movement of the haptic point in space can be perceived as movement of the point around the palm or along a finger for example.

The term ‘haptic path’ has similar meaning to haptic point except it creates the perception of a continuous line, curve or other geometric path.

Haptic points and haptic paths and can be generalized to surfaces, volumes and other haptic entities. This description will use points and paths without loss of generality.

‘Haptic entities’ may have properties that affect how they are perceived, for example position, size, orientation, intensity, roughness, sharpness or any other property could be defined.

The term ‘haptic emitter’ means a device that can create haptic entities. The haptic emitter receives instructions identifying the properties of the entity to create including its shape, size and position. Positions are specified in relation to the ‘haptic frame’, which is a 3-dimensional coordinate system within which positions relative to a datum point on the haptic emitter can be described.

Note that this description refers to mid-air haptics but could apply in any acoustic medium. Similarly, examples are based around the common case of a hand, but any part of the body could equally be used.

Data discussed herein may be received over a computer network and/or a removable storage medium.

Output subsystems may include audio subsystems, visual output subsystems and computer network subsystems.

### II. A Haptic Point Attached to a Finger Tip

One basic use for mid-air haptic mediated HCI is to indicate to a user that a part of their hand is currently being tracked so that its position and orientation can be used as input data for the interaction. It is desirable to produce a haptic point localized to the relevant part of the hand so that the user is aware that tracking is active but also exactly which part of the hand is being tracked.

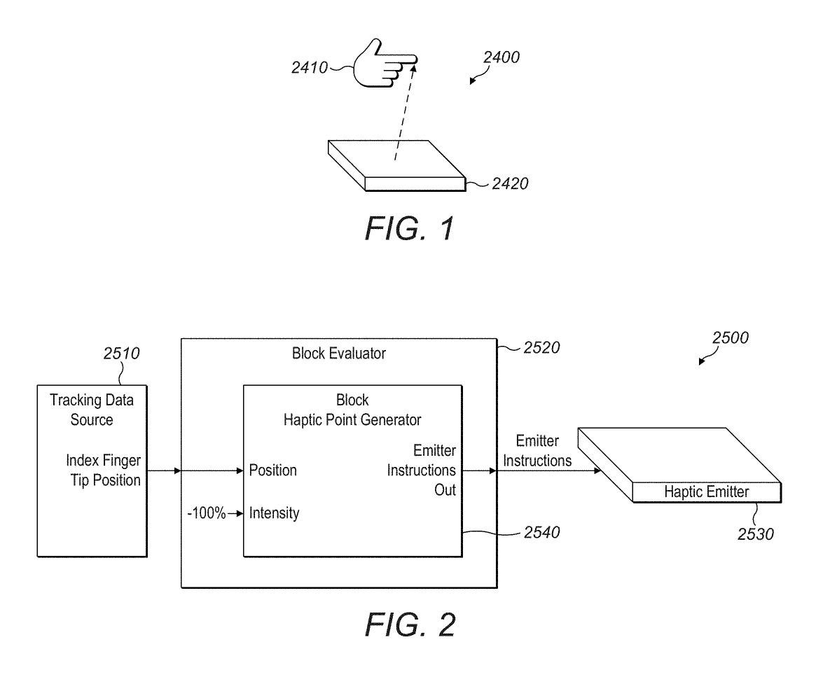

FIG. 1 shows a schematic example 2400, where it is assumed the relevant part of the hand 2410 is the index finger tip and it is assumed the availability of position information for the finger-tip relative to the haptic frame 2420 exists.

In the system 2500 depicted in FIG. 2, an Evaluator block 2520 is provided that evaluates a network of blocks having inputs and outputs. In this case the network contains a Haptic Point Generator block 2540 having ‘position’ and ‘intensity’ inputs. The evaluator maps data from data sources 2510 available to the system to the network inputs and routes data from the network outputs to the haptic emitter 2530. The ‘index finger tip position’ output of the ‘tracking data source’ 2510 is mapped to the ‘position’ input of the block 2540. The ‘emitter instructions out’ output is mapped to the haptic emitter 2530. The Evaluator block 2520 provides the facility to specify values to be mapped to any block inputs that are not mapped to other data sources. In this example, the value ‘100%’ is provided to the ‘intensity’ input of the block. The overall effect of this arrangement is that the user perceives a haptic point on their index finger tip whenever the system is operating.

### III. A Haptic Path Attached to the Palm

The system may operate by requiring the palm to be approximated by a plane, a 3D transform to be applied to the path and the ability to send a haptic path to the emitter.

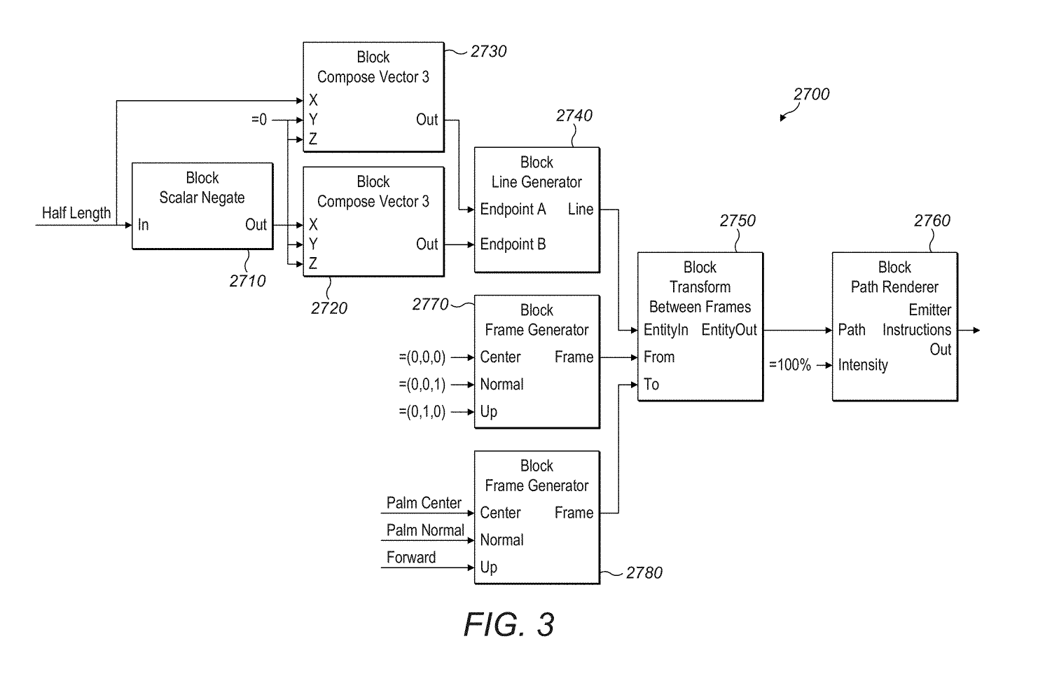

FIG. 3 shows an arrangement 2700 of blocks that produces a haptic line that tracks the position and orientation of the palm of a hand. A half-length inputs into a Scalar Negate block 2710 and a Compose Vector 3 block 2730. The output of the Scalar Negate block 2710 inputs into another Compose Vector 3 block 2720. Both Compose Vector 3 blocks 2720, 2730 input into a block line generator 2740, which outputs into a Transform Between Frames Block 2750.

A frame defines a 3D orthonormal coordinate system that is positioned and orientated relative to another frame. Frame Generator blocks 2770 and 2780 receive a point input, center, defining the origin of a frame and two direction vectors, normal and up, defining the direction of two of the three basis vectors for the frame. The third basis vector of the frame is computed as the cross-product of the first two. The Frame Generator block 2770 outputs the frame in which the line output from Line Generator block 2740 is considered to be defined and Frame Generator block 2780 outputs the frame relative to the emitter output frame in which the plane approximating the target hand is the xy-plane. Outputs from Frame Generator blocks 2770 and 2780 also inputs into a Transform Between Frames block 2750. The Transform Between Frames block 2750 outputs a new line that has been positioned and oriented so as to be within the plane approximating the target hand. The output of the Transform Between Frames block 2750 inputs into Path Renderer block 2760. The output of the Path Renderer block 2760 provides emitter instructions.

The overall operation of the network may be broken into three stages. First the macrogeometry of a haptic entity is calculated at the line output of Line Generator block 2740, the line being from a point in 3D space (−half length, 0, 0) to a second point (+half length, 0, 0). In the second stage, to create the illusion that the line is attached to a hand, the line must be moved and oriented to match the position and orientation of the hand and this is achieved by the Transform Between Frames block 2750. Finally the macrogeometry is converted to instructions to the emitter by the Path Renderer block 2760.

### IV. A Point that Attaches/Detaches in Response to a Gesture

A refined example includes mediation of the starting and stopping of an interaction when certain gestures are detected. Whether an interaction is currently in progress is then indicated to the user by the presence or absence of a haptic point.

A gesture is a pattern of input over time having certain detectable characteristics. Examples of gestures include flicking, swiping, twisting, tapping and other motions. The details of how to detect gestures are well known in related art.

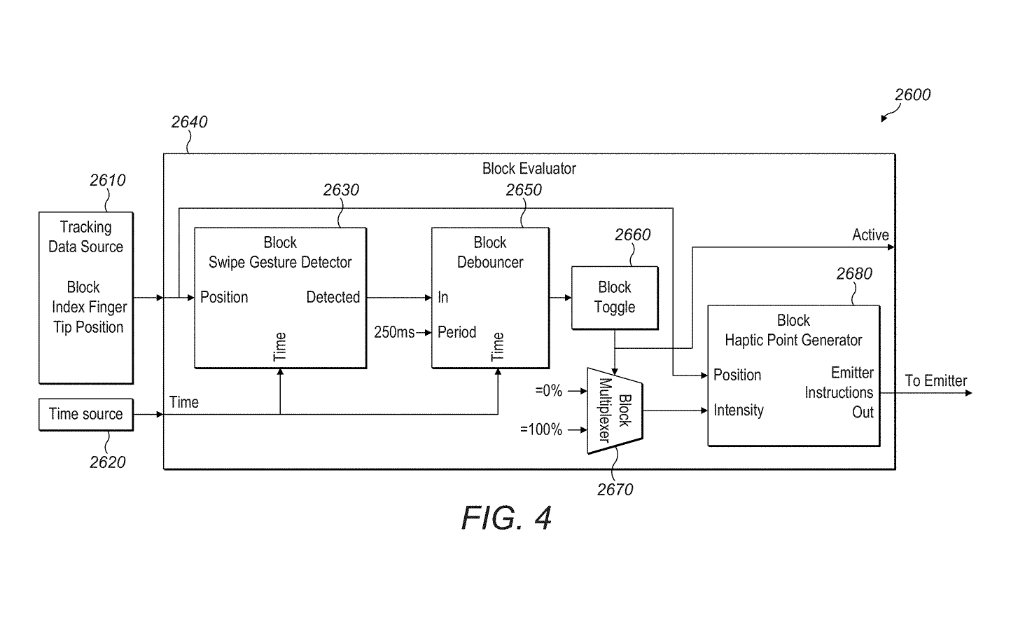

FIG. 4 depicts an arrangement 2600 of interconnected blocks that, when evaluated, detect a gesture and indicate whether an interaction is currently in progress both to the rest of the system in which the evaluator sits (via the ‘Active’ output) and to the user by the emission of a haptic point through the haptic emitter.

The Evaluator block 2640 repeatedly evaluates the network in response to changes in Index Finger Tip Position block 2610. The Swipe Gesture Detector block 2630 has an output ‘Detected’ that evaluates to the time when a sequence of values on the ‘Position’ input last described a movement that is consistent with the act of swiping. The Debouncer block 2650 has a Boolean output that on each evaluation evaluates to True if and only if the current value on its ‘In’ input is different than on the previous evaluation and less time has elapsed since the last change on the ‘In’ input than the value presented on the Period input (note that the handling of state to implement this behavior is described later). A time source 2620 provides a time signal to the Swipe Gesture Detector block 2630 and to the Debouncer block 2650.

The Toggle block 2660 has a Boolean input and Boolean output and on each evaluation flips the value on the output if the input value is True. The Multiplexer block 2670 has two inputs for values that can appear on the output and another input that controls which of the first two inputs' values is forwarded to the block's output. The Haptic Point Generator block's 2680 Intensity input is therefore presented with a value that toggles between 100% or 0% for each swipe gesture detected. The Haptic Point Generator block's 2680 Position input receives the current finger tip position. Therefore the Haptic Emitter receives instructions that cause it to generate a haptic point at the location of the finger tip that toggles on or off after each swipe gesture made with the finger tip.

One notable feature of FIG. 4 is that gesture- and haptic-related blocks are intermingled and processed by the evaluator in a closely coupled fashion. Ordinarily these concerns would be separated and processed in disparate parts of the system. Close coupling offers advantages both at design-time and run-time. At design-time the choice of gesture and haptic feedback styles can be readily chosen to complement each other and implemented in one place, saving design and implementation effort. At run-time, the close coupling ensures that the gesture recognition and haptic generation blocks receive the same data with low latency between them giving rise to a higher quality user experience because the user perceives the highest possible degree of consistency between their actions and the feedback they receive.

### V. A Plunger that Modulates Macrogeometry Depending on the Plunger Position

Whereas the previous example described changing the system state in response to a gesture, it is also possible to modulate the haptic feedback continuously to provide the user with richer information about the system's response to input as the interaction progresses as will now be described.

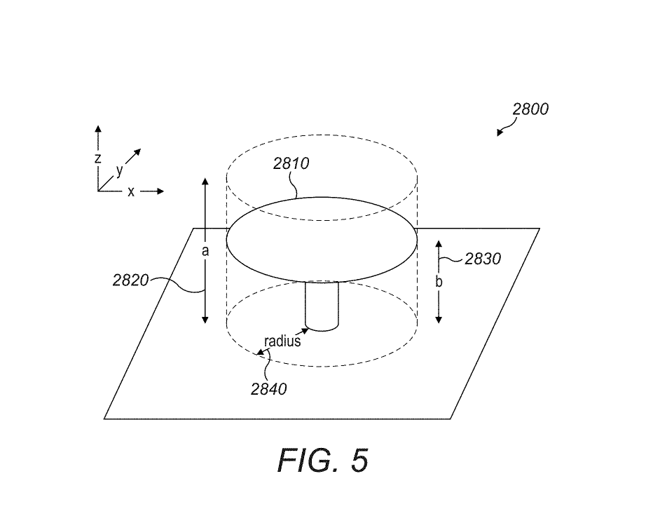

FIG. 5 shows a cylindrical zone 2800 that conceptually acts as a plunger 2810 having a radius 2840 in that the height of the lowest point b 2830 on the part of the hand that is in the cylinder with height a 2820 will be used to modulate the haptic output to indicate to the user the position of the plunger.

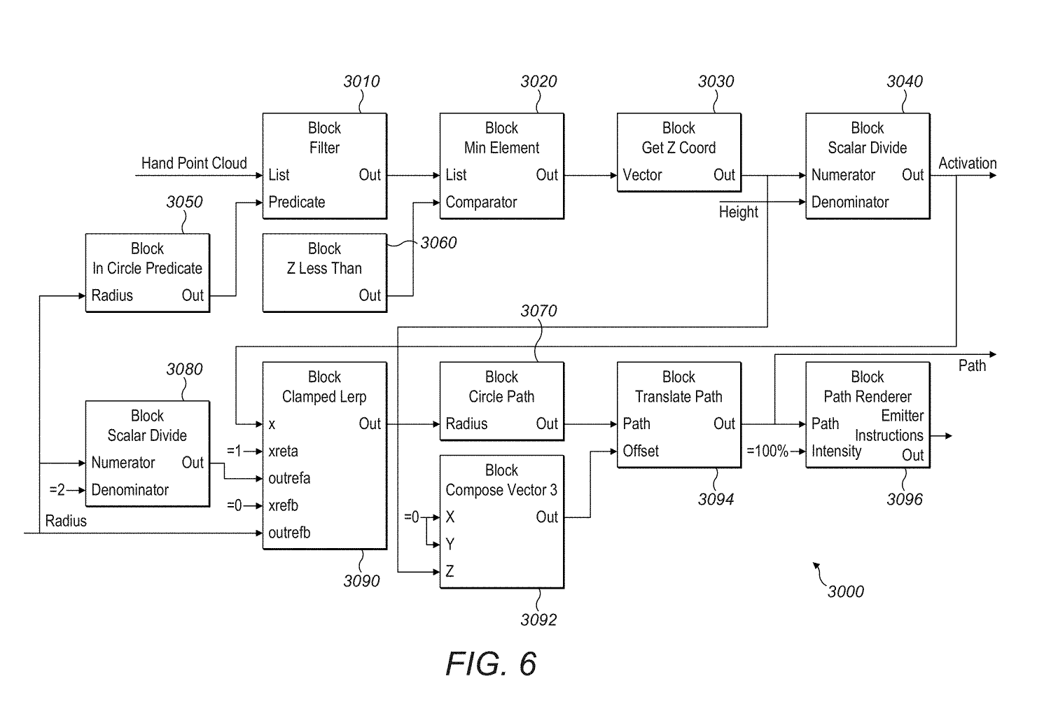

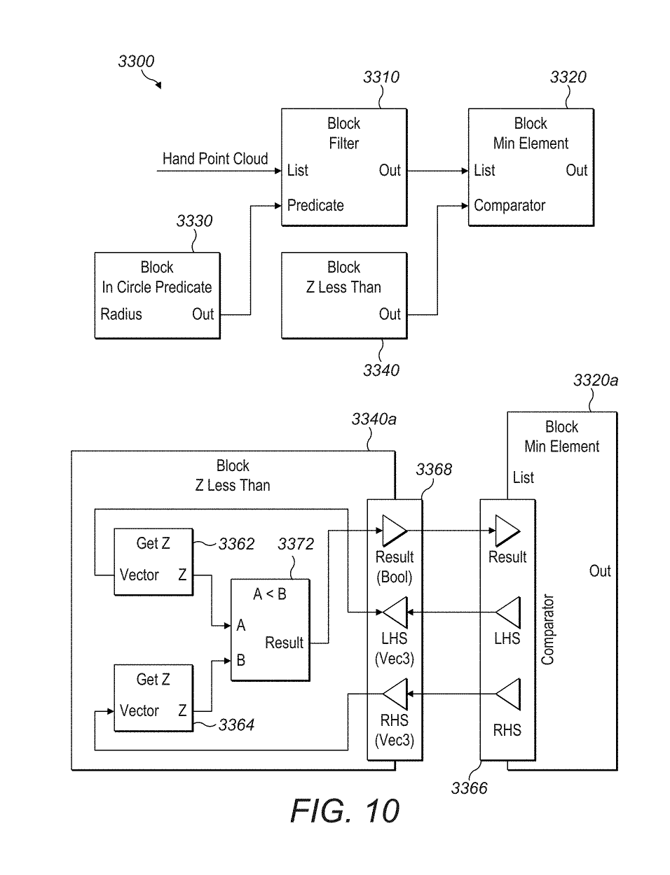

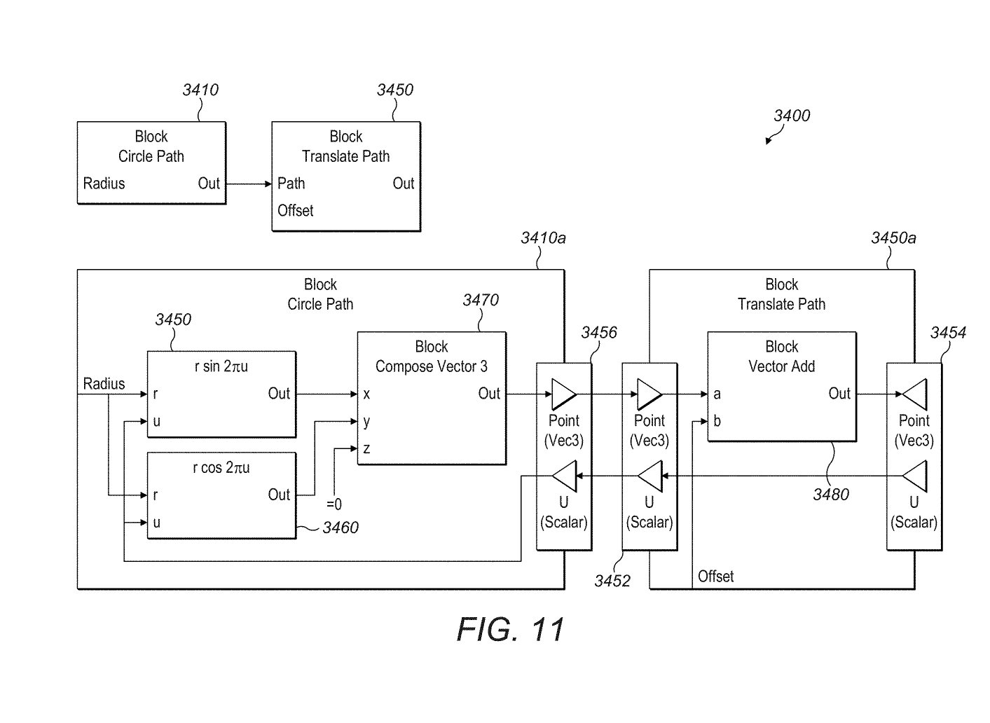

FIG. 6 depicts a block network 3000, for evaluation by a Block Evaluator, that implements the plunger behavior as follows. The Hand Point Cloud top-level input into a Filter block 3010 provides a set of point values sampled from a detected hand (as can be obtained from a time-of-flight camera for example). The Filter block 3010 takes the list of values on its List input and outputs a new list to the Min Element block 3020 that is the subset of values containing only those that satisfy the predicate provided on the Predicate input. In this case, the predicate is the In Circle Predicate block 3050 which causes the selection of points that are within a circle of given radius provided on the Radius input (the construction of such a predicate is described later with reference to FIGS. 10 and 11). The filtered list is then searched to find the lowest point by using a combination of the Min Element block 3020 and Z Less Than block 3060. The Min Element block 3020 selects the minimum value in a set as ordered by a given comparator. The Z Less Than block 3060 defines a comparator that determines which of two given points has the lower z coordinate. The Get Z Coord block 3030 takes a 3D point as an input and outputs the z-coordinate of that point. Therefore, the Out output of the Get Z Coord block 3030 evaluates to the z-coordinate of the lowest point that is within the cylinder of the plunger. The Scalar Divide block 3040 connected to the Get Z Coord 3030 block output divides a scalar value on its numerator input by the scalar value on its denominator input. This is connected to a top-level input that provides the height of the cylinder of the plunger (denoted a 2820 in FIG. 5). The Clamped Lerp block 3090 therefore receives a scalar value in the range 0 to 1 on its ‘x’ input. The Scalar Divide block 3080 receives the Radius input on its numerator input and a constant 2 on its denominator input so that its output is half the radius and inputs to the outrefa input of Clamped Lerp block 3090. The Radius inputs to the outrefb input of Clamped Lerp block 3090.

The Clamped Lerp block 3090 performs a linear interpolation function, well known in the art, to map the scalar value on its x input in the range xrefa to xrefb linearly into the range identified by the values on outrefa and outrefb inputs, which are arranged to be half the cylinder radius and the cylinder radius respectively. Therefore the Circle Path block 3070 receives on its Radius input a scalar that decreases from the cylinder radius to half the cylinder radius as a hand moves down through the cylinder. The Circle Path block 3070 produces a circular path of the necessary radius centered on the origin in the xy-plane. The Translate Path block 3094 also receives input as an offset from the Compose Vector 3 block 3090 whose input is zero in the X and Y directions and the output of the Get Z Coord block 3030 in the Z direction. The offset input of the Translate Path block 3094 is therefore a point on the axis of the cylinder at the height of the lowest point of any point from the Hand Point Cloud. This allows the Translate Path block 3094 to position the circle received on its path input so that it coincides with the lowest point of the hand interacting with the plunger.

Finally the Translate Path block 3094 translates the circle path so that it is moved to the height of the lowest hand-point-cloud point in the cylinder calculated elsewhere in the network and described above. The translated path is converted to instructions to be sent to the Haptic Emitter by the Path Renderer block 3096.

### VI. Local Geometry

The perceived qualities of a haptic entity depend on spatial and temporal features at different scales simultaneously in the same way that solid object can be both smooth on a small scale and bumpy on a medium scale for example. The present invention provides the ability to readily combine the effects of blocks or sub-networks each concerned with features at different scales as will now be described.

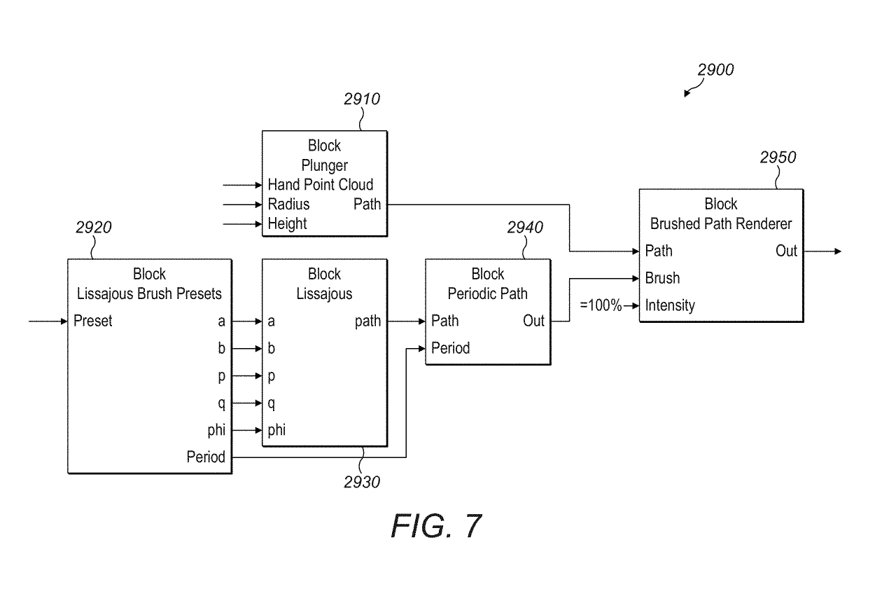

FIG. 7 shows a schematic 2900 where the Brushed Path Renderer block 2950 has Path and Brush inputs that each receive a Path. The Path input comes from a Plunger block 2910 and the Brush input comes from Periodic Path block 2940. The ‘Path’ input determines the macro-geometry of the output and the ‘Brush’ input determines the microgeometry of the output. The output is a path made by superposition of the two input paths. In this example, the microgeometry is a Lissajous curve and the macro-geometry is given by the Plunger block 2910, which is the network of FIG. 6 without the Path Renderer block 3096. The Lissajous curve parameters are provided by the Lissajous Brush Presets block 2920 which translates a preset index on its input into a set of parameters previously determined to be a desirable combination. The Lissajous block 2930 outputs a path from the well-known Lissajous family of curves. The a and b inputs adjust the frequency of the two sinusoids that compose the curve, the p and q inputs adjust the amplitude and the phi input adjusts the phase offset between the two sinusoids.

The Periodic Path block 2940 allows for the adjustment of the number of repetitions of the brush path for each traversal of the macro-geometry path. The overall effect is that the perceptual properties of the plunger haptic entity can be adjusted independently of its macroscopic qualities like size and shape. Moreover, the ability to adjust perceptual properties has been added to a pre-existing haptic entity by the addition of a new sub-network without the need for heavy modifications to the original network.

### VII. Non-Affine Modulation

The plunger examples describes a system in which the overall effect of the modulation is to apply an affine transform to the haptic entity being generated. An advantage of the freedom provided by the present invention is that a network of blocks in which modulation can be applied to part of the network while leaving other parts unaffected is easily possible. This is particularly relevant in the presence of microgeometry because changes to scale, speed or other characteristics of the microgeometry can substantially affect what a user perceives. Therefore, if it is desired to modulate the size of a macro-geometry path or the speed at which it is traversed the modulation must be decoupled from the generation of the microgeometry.

Another example of non-affine modulation is to generate a haptic point following a circular path at some frequency then modulating the radius of the path at a higher frequency.

### VIII. Modulating Haptic Output According to Characteristics of the User

FIG. 4 shows a multiplexer block used to reduce intensity to 0 when the Active output is false. Combination of the In Circle function of FIG. 6 and the multiplexer can be used to disable haptic output unless a hand is present to perceive it.

A refinement of this is to modulate the haptic output in response to the tactile sensitivity of the skin being stimulated.

### IX. Synchronizing Other Parts of the System with the Results of Block Evaluation

The effectiveness of an interaction can be increased dramatically by stimulating multiple senses in unison with the haptics, for example: visualizing the system state through indicator lights or graphics, or generating sounds when certain events occur.

The present invention facilitates the synchronization of multiple parts of the system without imposing overly restrictive constraints on those parts. This will now be described by considering the examples of a switch that generates an event when a plunger moves beyond a certain position. The movement of the plunger and the activation of the switch are indicated via haptics but also via sound and graphics.

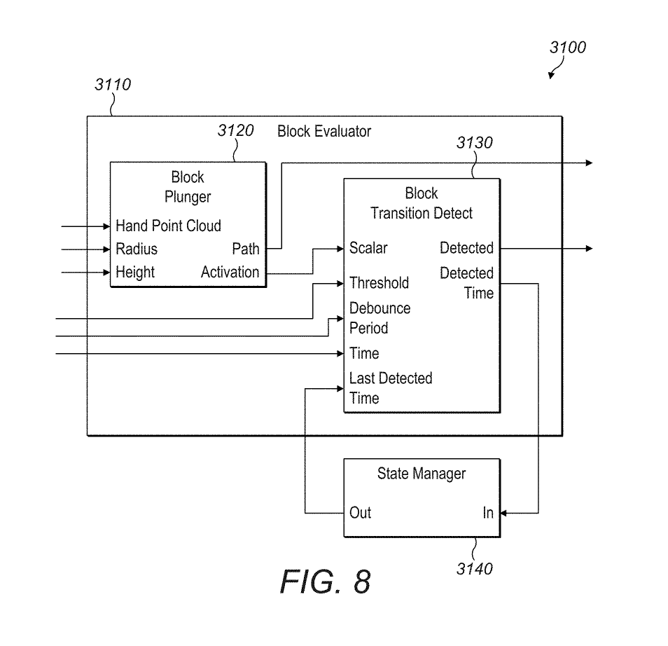

FIG. 8 depicts a schematic 3100 of the augmentation of the plunger arrangement of FIG. 6 with a sub-network that adds an output that evaluates to True whenever the plunger is pushed below a certain threshold. The Plunger block 3120 embodies the network of FIG. 6 with the Activation output being the value of the first Scalar Divide block 3040. The Transition Detect block 3130 produces a True value on its ‘Detected’ output at most once for each ‘Debounce Period’ when the Scalar input moves below the Threshold value. To determine if the last detection was within the debounce period, the block must ‘remember’ the time of the last detection and compare that to the current time. This state is held in the State Manager 3140 that accompanies the Evaluator block 3110. The two elements are operated in concert by the system to provide the capability for the block network to influence the inputs it receives on future evaluations as will be now be explained.

### X. Stateless Blocks Facilitate Usability and Run-Time Optimization

In the present invention, state is managed externally to the block network so that each block is ‘functional’ in the ‘functional programming’ sense—there are no side effects and presenting the same inputs always yields the same outputs. One advantage of this scheme is that it enables optimization when some of the network must be reevaluated more often than other parts. For example, if the output rate is many kHz, but some inputs are updated only at 10 s of Hz, then the evaluation of sub-networks with unchanged inputs can be skipped.

Secondly, when debugging, state can be recorded, made visible and replayed. This is important when inputs are coming from things like waving hands that are very difficult to reproduce. Also if blocks were stateful, then once a block has been driven into a state it would be difficult to go back in time (the state has to be reset). Stateful block also make it difficult to try out scenarios that require a certain state to be entered—in contrast, the functional arrangement allows a state to be entered by providing the appropriate output from the State Manager.

### XI. Input and Output Interface Metadata

The collection of inputs and outputs on a block constitute its interface. In a network, a first block with a given interface can always be substituted for a block that has an interface that is the same or is a superset of the first block's interface. The substitution may result in a situation where only a subset of the inputs and outputs of the substitute block are connected. It is therefore possible that a block that is not fully connected in a network can be substituted with a block that has an interface that has amongst its inputs and outputs a subset that matches the subset that are connected in the block to be substituted.

When performing a substitution, it must be possible to map the inputs and outputs on the substitute block to those of the block to be substituted. The mapping is determined by examining information, known as metadata, associated with the inputs and outputs.

Metadata may include, for example, information about the types of data that the inputs and outputs can convey, the semantic meaning of the data conveyed through the inputs and outputs, the set or range of permitted values at an input or the set of values that an output can produce.

Metadata can be used by tools for processing block networks for a range of purposes including facilitating editing of the network by automating the creation of connections between blocks or at least making it easy to connect inputs and outputs in accordance with their data types or semantic information.

### XII. Automatic Input and Output Mapping

The metadata associated with inputs and outputs can be used to simplify the integration of blocks into systems where the block designer and system designer are working independently of each other. A system may provide data about the user and environment of various types and semantics, for instance a subset of the data may pertain to the recognition of a certain gesture and the parameters of the recognized gesture such as its direction and length. A block designer may provide a set of blocks each of which has an input or inputs that can, for example, be used to trigger the generation of a haptic entity with a certain size. A problem can arise when a third-party system integrator wishes to combine the data provided by the system with the independently designed blocks because the interface of the blocks may not be trivially satisfied by the data provided by the system.

Suppose for example that a set of blocks is provided each with the following input interface:

| Input Name | Type |
|---|---|
| Centre | Vector3 |
| Scale | Scalar |
| Duration | TimeInterval |

And suppose that a system provides data on a range of gestures that it can recognize:

| Name | Type | Metadata |
|---|---|---|
| LeftSwipeStartTime | TimeInstant | Group = LeftSwipe, |
| | | Type = StartTime |
| LeftSwipeEndTime | TimeInstant | Group = LeftSwipe, |
| | | Type = EndTime |
| LeftSwipeStartPos | Vector3 | Group = LeftSwipe, |
| | | Type = StartPos |
| LeftSwipeEndPos | Vector3 | Group = LeftSwipe, |
| | | Type = EndPos |
| RightSwipeStartTime | TimeInstant | Group = RightSwipe, |
| | | Type = StartTime |
| RightSwipeEndTime | TimeInstant | Group = RightSwipe, |
| | | Type = EndTime |
| RightSwipeStartPos | Vector3 | Group = RightSwipe, |
| | | Type = StartPos |
| RightSwipeEndPos | Vector3 | Group = RightSwipe, |
| | | Type = EndPos |
| TimeNow | TimeInstant | Type = TimeNow |

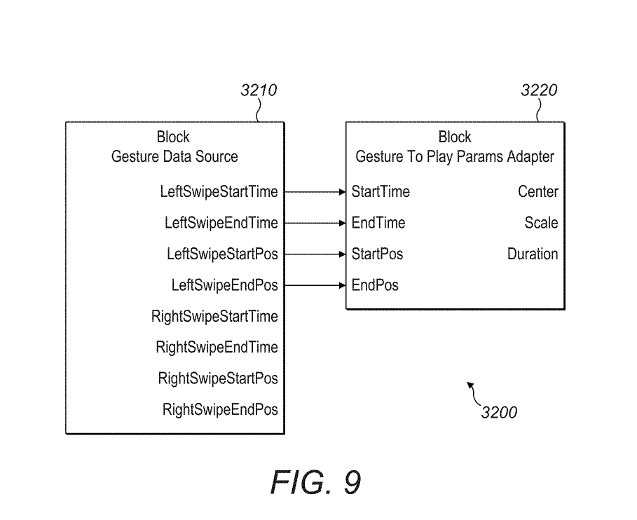

The LeftSwipe and RightSwipe groups have a common interface: StartTime, EndTime, StartPos, EndPos. The third-party system integrator provides an adapter block that converts the system data source interface for a gesture to an interface compatible with the sink block's input interface, as shown in FIG. 9. FIG. 9 shows a schematic 3200 of a Gesture Data Source block 3210 where left swipe-related data will output to a Gesture to Play Params Adapter block 3220. FIG. 9 shows the adapter applied to the interface identified as the LeftSwipe group by the metadata associated with the Gesture Data Source block 3210. The adapter could equally be applied to the RightSwipe group, or a second adapter applied to that group depending on the needs of the interaction scheme being defined Input interfaces may be provided with gesture data, user parameters or operating environment parameters.

Where the adapter block for a given data source and sink block can be identified unambiguously from the meta data provided on the blocks and their inputs and outputs, then construction of the connectivity to perform adaptation can be generated automatically. One example of how this manifests in a UI in a workflow as follows:
User selects a block to evaluate
All relevant data source interfaces for the chosen block's sink interfaces are automatically identified by searching for adapters with matching metadata
User selects a data source (e.g. specific gesture recognizer) for each sink interface
The system generates the appropriate adapter connectivity
Evaluation proceeds

### XIII. Using Blocks for Purposes Other than Haptic Generation

Although the present invention is specialized for and described in relation to its application in the field of haptic generation, it is generally applicable to other problems. This becomes a distinct advantage when a multi-modal sensory experience is being created. For example, perception of friction is a function of stimulus perceived through touch, sight and sound (Guest, S., Catmur, C., Lloyd, D. et al. Exp Brain Res (2002) 146: 161. https://doi.org/10.1007/s00221-002-1164-z). As a user interacts with a simulated texture, the velocity of their movement can be used to modulate synthesized sound. The present invention can be used to implement the sound synthesis and modulation algorithms, ensuring that the entire experience is coherent and that implementation of textures using sound can be treated by non-experts as a ‘black-box’.

### XIV. Composing from Library Blocks and the Use of Channels within Ports to Provide First-Class Function and Closure Capabilities

Examples so far have shown blocks being reused in different situations, giving programmers the benefits of saved time and higher quality results compared to providing all the blocks themselves. There are some reuse patterns that are made possible by certain novel features of the block definition scheme.

The connections from output and to input ports have so far been depicted as ‘atomic’ (featureless) entities where in fact they have internal structure in the form of channels as shown in FIGS. 10 and 11.

FIG. 10 shows a schematic 3300 part of a previously described design in which a Min Element block 3320a has a Comparator 3366 input. The Z Less Than block 3340a provides an output such that when connected to the Min Element block's 3320 Comparator 3366 input, the Out output will evaluate to the element of a list of 3D points at the List input that has the lowest ‘z’ component. A Filter block 3310 takes an input from an In Circle Predicate block 3330 and outputs to an Min Element block 3320.

A key difference between evaluation in the simple case where each connection conveys a single data item and this case is that the number of comparisons carried out by the Min Element 3320 block is proportional to the number of elements in the list.

In order for the comparison operation to be defined using blocks, channels are provided within ports. For each element in the list, the Min Element detailed block 3320a evaluates the Comparator input 3366 by providing the current element and the lowest element encountered so far on the left-hand side (LHS) and right-hand side (RHS) channels. The current block graph evaluation is then suspended, a new evaluation of the sub-graph that produces the value on the Result channel is carried out and then the original block graph evaluation is resumed. Specifically, the detailed Z Less Than block includes two blocks with GetZ blocks 3362, 3364 with inputs from the LHS and RHS channels. The results of the inputs of these blocks is processed in the A<B block 3372 that feeds into the interface block 3368 that feeds into the comparator 3366. Thus, in FIG. 10, the evaluation of the Result channel of the comparator connection ultimately receives all input from other channels of the same port.

FIG. 11 shows another application of channels showing how the scheme can be used to represent geometric paths. A Circle Path block 3410 and Translate Path block 3450 are shown in detail blocks 3410a, 3450a.

A geometric path can be regarded as a function mapping a scalar in the range 0 to 1 to a point in space. When varying the scalar continuously from 0 to 1, a continuous path is described. Path representations of geometry are advantageous because downstream blocks can evaluate the path at one or more points allowing, for example, estimation of the gradient at a point.

To evaluate the Point channel in interface block 3454 of the ‘Out’ output port of the Translate Path block 3450a, a scalar is provided on the u channel and evaluation proceeds to evaluate the ‘Out’ output of the Vector Add block 3480. Its ‘a’ and ‘b’ inputs must be evaluated. The ‘a’ input is evaluated by tracing the connectivity to the Compose Vector 3 block 3470 via interface blocks 3452, 3456 and evaluating that and so on. The ‘b’ input of the Vector Add is connected to a top-level input.

The scalar on the u channel is input into two blocks 3450,3460 along with the radius input. A r sin 2πu block 3450 outputs to the x entry of the Compose Vector 3 block 3470. A r cos 2πu block 3460 outputs to they entry of the Compose Vector 3 block 3470.

The significance of this is that, in addition to the situation described using FIG. 10, evaluation of a port with channels can depend both on ultimate inputs from channels in the same port, which may vary for each evaluation of the port, and on inputs or sub-networks that are effectively held constant for repeated evaluation of the channels—the two sources of inputs can be mixed freely.

It will be apparent to one skilled in the art that optimizations to avoid re-evaluating subnetworks that are bound to yield the same values as on previous evaluations can be applied.

### XV. Scaling Computational Intensity According to the Playback Environment (i.e. Computing/Output Equipment)

One of the main goals of the present invention is to provide a way of describing algorithms for data processing that are portable and reusable between different end applications. Some applications will make use of high-end computing hardware such as that used to generate virtual reality experiences, others will operate in highly constrained computing environments such as might be found in home appliances. To facilitate reuse, algorithm designers need to be able to ignore the constraints of the operating environment as much as possible and the present invention provides capabilities to achieve this as are now described.

FIG. 4 shows how the Block Evaluator is provided with inputs from a Tracking Data source and a Time source. Where a block has the appropriately identifiable interfaces, values are automatically provided. One such data source provides information about the execution environment such as CPU speed and capabilities, amount of memory, refresh rate of inputs and the output device capabilities. Such information can be processed by the block network in the same way as any other input and can be used to select between implementations of different profiles. For example, blocks that use trigonometric functions or calculate square-roots could switch between precise algorithms that are compute intensive, or approximate algorithms that use look-up-tables. Other examples of playback environment properties that can be used to influence haptic generation include movement velocity where a predictive element may be introduced at extra computational cost to target the hand at the predicted location after movement during the system latency, distance of a hand to the emitter where algorithms that use more power to produce stronger haptics may be switched in, or ambient noise levels when less computationally intensive methods that produce haptics without optimizing away unwanted sound when it will be masked by ambient noise.

### XVI. Metadata

To facilitate the application of blocks into real products it is necessary to facilitate the discovery, prototyping, design, implementation and deployment processes involved in getting a product with haptic enhancement to the market. The current invention provides a mechanism for associating additional metadata to blocks so that the information can be used to guide or automate the mentioned processes. Metadata can be attached as name-value pairs to any block, port, connection or other element of the block network. Naming conventions using names such as ‘Name’, ‘Type’ or ‘Documentation’ are used to enable tools used in the production process to analyze, categorize and present blocks and their metadata to users so that the production process is made more efficient and effective.

During the discovery phase documentation and categorization of the blocks available for use in a project is important. Inputs are labelled with default values such that a generic block browser can be used to present any given block to a user both on screen and through a haptic emitter without the user having to have prior knowledge of how to configure or drive the block. Blocks and their inputs and outputs are labelled with documentation describing their purpose and correct usage. Outputs of blocks with multiple outputs are labelled with their purpose, for example haptic output, debug output, visualization output, sound output.

For blocks that are a sub-part of larger block networks, cross-references into a library of examples in which the block can be found is generated so that the block can be seen being used in context.

During the prototyping/design phase, the rapid creation and trialing of new block networks is prioritized. Metadata on input and output ports allows automation of block selection and connection, for example by filtering the list of available blocks down to those having inputs that could be correctly used in conjunction with a given output. Such filtering allows someone with limited knowledge of the available blocks to discount unproductive possibilities and limit their exploration to productive regions of the solution space.

Metadata on outputs that highlights them as debug or visualization outputs can be used in design tools to evaluate and display information about the functionality of the block network under development. Inputs carry metadata relating them to visualization data so that the input controlling, say, the radius of a circle can be rendered in a visualization and presented to the user for editing/interaction in a way appropriate to the tool.

During the implementation phase meta data on blocks relating to the requirements they make on the execution environment such as computational intensity, memory consumption and hardware minimum requirements can be used to maintain an estimate of whether a given block network will be deployable on a target device (or an estimate of the required parameters of a target device if there is a choice).

During the deployment phase, meta data on blocks is used to schedule the blocks in the network to appropriate computing resources depending on computational load and available resources.

### XVII. Additional Disclosure

A haptic output entity with microgeometry that may vary in response to a first input of a midair haptic feedback system and macrogeometry that may vary in response to a second input of a midair haptic feedback system. The midair haptic feedback system may be capable of receiving data encoding a haptic entity and, after reception, output the encoded haptic entity.

The macrogeometry may vary in response to a first input of a midair haptic feedback system and the microgeometry may remain unchanged as a second input varies.

The microgeometry may vary in response to a second input of a midair haptic feedback system and the macrogeometry may remains unchanged as a first input varies.

A midair haptic feedback system may include: (a) a facility based on a first input and a second input to record and replay a first input and a second input; (b) a facility based on a first input and a second input to query values of intermediate calculations; and (c) a facility based on a first input and a second input to input simulated input values.

### XVIII. Conclusion

While the foregoing descriptions disclose specific values, any other specific values may be used to achieve similar results. Further, the various features of the foregoing embodiments may be selected and combined to produce numerous variations of improved haptic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A midair haptic feedback system, comprising:
a haptic output entity with microgeometry that varies in response to a first input of the midair haptic feedback system and macrogeometry that varies in response to a second input of the midair haptic feedback system;
wherein the midair haptic feedback system is capable of receiving data encoding a haptic entity and, after reception, output the encoded haptic entity.

2. The midair haptic feedback system as in claim 1, wherein the microgeometry is a Lissajous curve.

3. The midair haptic feedback system as in claim 1, wherein the encoded haptic entity outputs a path from a Lissajous family of curves.

4. The midair haptic feedback system as in claim 1, wherein when the macrogeometry varies in response to the first input of the midair haptic feedback system, the microgeometry remains unchanged as the second input varies.

5. The midair haptic feedback system as in claim 1, wherein when the microgeometry varies in response to the second input of the midair haptic feedback system, the macrogeometry remains unchanged as the first input varies.

6. The midair haptic feedback system as in claim 1, further comprising:
a facility based on the first input and the second input to record and replay the first input and the second input.

7. The midair haptic feedback system as in claim 1, further comprising:
a facility based on the first input and the second input to query values of intermediate calculations.

8. The midair haptic feedback system as in claim 1, further comprising:
a facility based on the first input and the second input to input simulated input values.

9. A midair haptic feedback system, comprising:
a data receiver to receive data encoding an interaction scheme and to process inputs to generate haptic output according to the interaction scheme.

10. The midair haptic feedback system as in claim 9, wherein the interaction scheme varies a property of a haptic entity as a function of an input to the midair haptic feedback system.

11. The midair haptic feedback system as in claim 9, wherein the interaction scheme varies a macrogeometry of a haptic entity as a function of an input to the midair haptic feedback system.

12. The midair haptic feedback system as in claim 9, wherein the interaction scheme varies a microgeometry of a haptic entity as a function of an input to the midair haptic feedback system.

13. The midair haptic feedback system as in claim 9, wherein the interaction scheme varies a property of a haptic entity when an input to the midair haptic feedback system passes a threshold.

14. The midair haptic feedback system as in claim 9, wherein the interaction scheme varies a property of a property of a haptic entity in response to a gesture.

15. The midair haptic feedback system as in claim 9, wherein the data is received over a computer network.

16. The midair haptic feedback system as in claim 9 wherein the interaction scheme synchronously outputs from a haptic output subsystem and a second output subsystem.

17. The midair haptic feedback system as in claim 9, wherein the haptic feedback system further comprises:
a second data source having second data;
second received data defining an adapter block;
an interaction scheme having an input interface interaction scheme compatible with the adapter block;
wherein the second data from second the data source is provided to the input interface interaction scheme.

18. The midair haptic feedback system as in claim 17, wherein the second data comprises gesture data.

19. The midair haptic feedback system as in claim 17, wherein the second data provides user parameters.

20. The midair haptic feedback system as in claim 17, wherein the second data provides operating environment parameters.
